(19) United States
(12) Patent Application Publication
(10) Pub. No.: US 2008/0134723 A1
(43) Pub. Date: Jun. 12, 2008

(54) Method and Device for Bending Glass Sheets

(75) Inventor: Kenji Maeda, Jumet (BE)

Correspondence Address: AKERMAN SENTERFITT, P.O. BOX 3188, WEST PALM BEACH, FL, 33402-3188, US

(73) Assignee: AGC Flat Glass Europe, Jumet (BE)

(21) Appl. No.: 11/908,166

(22) PCT Filed: Mar. 9, 2006
(86) PCT No.: PCT/EP06/60583

§ 371 Date: Sep. 10, 2007

(30) Foreign Application Priority Data
Mar. 10, 2005 (BE) 2005/0129

(51) Int. Cl. C03B 23/023

(52) U.S. Cl. 65/106

(57) ABSTRACT

Method of bending sheets which consists of heating all of the sheets as they pass continuously into a kiln, up to a temperature close to the sheet-softening temperature, and applying localized heat on the pre-heated sheet in the zones that are to undergo the strongest curvature, said localized heating being performed with heating elements that are positioned opposite the zone with the strongest curvature. The progressive movement of the sheet is accompanied by the successive triggering of, or increase in the power delivered from one or more series of heating elements that are disposed opposite the zones of the sheets subjected to said additional heating operation.

The present invention relates to a process and a device for bending glass sheets.

Glass sheets are brought to a high temperature in order to bend them from flat sheets. The bending temperature to which softening of the glass corresponds lies around 600-700° C. Various techniques are used to carry out bending of glass sheets, depending on the nature of the glazing to be produced, its dimensions and its shape.

In the following, it is a question of bending a glass sheet, but the techniques described advantageously apply to the simultaneous bending of two glass sheets when these sheets are intended subsequently to be assembled in laminated form using an intermediate plastic sheet.

Various techniques are used for producing bent glazing especially glazing intended for the automotive industry. The choice between these techniques depends on both technical and economic factors. The complexity of the shapes to be produced and the high-output production capacities are the main factors.

The most widespread techniques for producing glazing having very accentuated curvatures comprise the forming, at least partly, of the glass sheet on a bending skeleton or frame which gives its profile to the periphery of the final glazing. The forming takes place at least partly by gravity on the frame.

The bending may be entirely carried out on the frame or also be the subject of a pressing operation which itself may relate either to limited portions of the surface of the sheet or to the entirety of the sheet. One method comprises, for example, a first formation of the glass sheet on the frame, followed by applying the sheet borne by the frame to a counter-mould.

Other techniques combine bending on a frame with a first forming on a conveyor formed by rollers of which the profile imposes, on the transported glass sheets, a curvature which becomes more pronounced during the progression of the sheets in the bending furnace.

The formation of the sheets according to the desired rigorous shape is all the more difficult to achieve when this shape comprises compound curvatures (bending known as spherical bending as opposed to the bending mainly along a single direction, known as cylindrical bending) and when one at least of the curvatures is of small radius.

When the small-radius curvature is located in proximity to the edges of the glazing, depending on the envisaged uses, the irregularities are sometimes tolerable. When this curvature is located far from the edges, the defects are much more troublesome. The production of such glazing poses problems that the prior techniques can only solve with difficulty, for various reasons.

The bending techniques in question above are all strictly dependent on the thermal conditioning of the sheets. Deformation by gravity is obviously directly dependent on the temperature which conditions the softening of the glass. Even when the deformation is partly carried out by pressing, the temperature at which this is carried out is important in so far as it controls the degree of ease of deformation and consequently the forces to be applied and the stresses that result therefrom in the sheet.

The distribution of the temperatures makes it possible to bend the sheets under better conditions and depends on the shape of the glazing produced. This distribution and its application over the time of the process may be relatively difficult to produce in conventional furnaces.

Conventional bending furnaces mainly comprise heating elements distributed above and below the glass sheet. In addition, heating elements are positioned on the sidewalls to maintain a high temperature uniformity at any point in the furnace. To some extent, the distribution of the heating elements over the path of the sheets, both longitudinally and transversely to the progression, makes it possible to modulate the temperature on the surface of the sheet.

To achieve temperatures that are very different or, as is equivalent, significant temperature gradients over zones having dimensions limited by the sheets, it has been proposed in the prior art to place heating elements in proximity to the glass sheets at locations that require a greater supply of heat. The configuration of the furnaces may partly be adapted to this mode of operation as long as the heating elements can be positioned for a sufficiently long time opposite the zones concerned so that the local heating reaches the desired gradient. One difficulty then lies in the techniques for which the glass sheet cannot be immobilized during this localized heating operation, whether it is carried out, for example, on forming rollers or, when the sheet rests on a bending frame.

The object of the invention is to resolve this difficulty. For this, the invention proposes to ensure that the localized heat supply follows the progression of the glass sheet.

Since the production rates are fixed as high as possible, the progression of the sheets is relatively rapid. Under these conditions, it is not possible to provide a movement of the localized heating elements that accompanies, in a synchronized manner, the progression of the glass sheets. To some extent, it is possible to arrange the mobile heating elements opposite the glass sheets, but independently of the difficulty that there may be in arranging the mechanisms that provide the movement of the heating elements, the range of movements it is possible to make does not allow a sufficiently prolonged following of the sheets to make it possible to attain the required temperature gradients.

The invention proposes solving this problem by arranging, in the path of the glass sheets, a set of heating elements having reduced dimensions, of which the operation is controlled in a programmed way so that the running of these heating elements accompanies the progression of the sheet to be treated.

The position of these heating elements in the progression direction of the sheets depends on the zones of the sheets which have to have the highest temperature. The heating which has to create a local temperature gradient, takes place however when the sheets are ready for bending following accentuated curvatures. The gradient is gradually reduced over time. It is therefore important to produce this gradient when the sheet has already been brought to a temperature close to that at which the bending is carried out.

In practice, advantageously according to the invention the additional localized heating of the sheet is carried out after it has been brought to a temperature close to the softening point which permits the limited overall bending. This local supply may be carried out in one zone where the supply of heat by conventional means is completed or still continues. For the glass sheets usually treated, silica-soda-lime glass of which glazing intended for the automotive industry is especially composed, the initial temperatures from which a local overheating is carried out are above 550° C. and usually above 600° C.

The rate of progression of the glass sheets in the highest-performing bending installation achieves and even exceeds 10 cm/s. When the zone which must be “overheated” is of relatively limited size, a few tens of centimetres for example, the passage under a heating element is at most only a few seconds. The heat capacity of the glass and a limited thermal conductivity even at the bending temperature however require, in practice, a not insignificant treatment time in order to form the desired temperature gradient. For this reason, it is necessary to ensure that several elements located one after another can successively heat the zone of the sheet which must have local overheating.

Furthermore, the location of the zones which must bear this overheating is not generally oriented along a direction parallel to the progression of the sheets, and does not necessarily extend over the entire height of these sheets. For these reasons it is necessary to ensure that the operation of the heating elements providing the local overheating on the one hand only heats the zone in question to the exclusion of the neighbouring zones (to form the necessary gradient) and, on the other hand, that the movement of the sheet is followed by that of the heating elements involved for this overheating.

One particular difficulty to solve is linked to the inertia which characterizes the heating devices. It is necessary to ensure a location as precise as possible for positioning the elements, of which the temperature rise is as fast as possible, and similarly of which the decrease which follows is carried out rapidly. Heating elements which have the first characteristic are found commercially. On the other hand these same elements, or rather their casing, have, as will be seen in more detail later on, a certain thermal inertia so that the temperature drop is never as fast as would be desirable in order to be able to have an instantaneously adjustable heat source in order to follow all the most suitable conditions. For this reason, the control of the heating elements must be carried out following a relatively complex process which integrates this particularity.

The operation of the heating element or elements used is controlled by the dimensions of the zone of the sheet which must be overheated. It is also a function of the rate of progression of the sheets and of the dimensions of the heating element or elements used for this localized heating. It is finally a function of the thermal characteristics of the heating element or elements, and also of the distance from this (or these) to the glass sheet.

All the preceding considerations (thermal inertia, rate of the sheets, size of the treated zone, size of the heating elements, etc.) means that, in practice, the operation of the heating element or elements is usually intermittent. Each element is put into operation for the time that approximately corresponds to the passing of the glass along this element. The successive elements, when several heating elements are used, reproduce the same cycle with a translation that corresponds to the movement of the glass sheet.

The operation of each heating element may be “on/off”. The heating elements may also follow a different operating cycle. For example, they may be maintained between a relatively low base power, and set at a higher power during passage of the zone of the sheet to be overheated.

The contiguous heating elements may operate successively or, at least over one part of their operating cycle, simultaneously. Taking into account the normal travelling rates of the glass sheets in the bending ovens, the successive operation probably corresponds to the most useful form. The start of the operation of the successive elements may also comprise a longer or shorter time interval during which no element is supplied with power or supplied with power in such a way as to deliver a more limited power.

By way of indication, elements with dimensions of around ten or so centimetres, for travelling rates of the glass of around 10 cm/s, could thus result in changing the operating time from around 0.2 to 2 s for zones to be treated of a few tens of centimetres.

To better respond to the requirements relating to the thermal conditioning of the sheets, the elements for local heat supply must be able to establish momentary local temperature differences with the remainder of the sheet that are sufficient to facilitate the bending along radii of curvature of small dimensions and leading to arcs with an angle which may range up to go degrees. The targeted gradient is that which corresponds to the average temperature in the thickness of the glass sheet, being understood that in practice the localized heating elements are located for ease on a single side of the sheet, the gradient will be greater on the side of the sheet directly exposed to the heating elements in question.

The working gradient is a function of the method for obtaining the accentuated curvatures. It is greater for curvatures which are only produced by bending under the effect of gravity. When the operating process comprises pressing means the gradient may be a lot less marked.

The smaller the radii of curvature and the more pronounced the curving effect, the higher the gradient has to be. Depending on the curving effect, and for processes in which only gravity is involved, the gradient may range up to 125° C./0.1 m. Such high values correspond, for example, to the formation of glazing known as “panoramic” glazing, in which the glass sheet is overall U-shaped, the central part of the glazing being flanked by two side parts located in planes practically orthogonal to this central part.

When the curving effects are less marked, and especially when the technique used comprises the use of pressing means, the gradient may be substantially lower and may be established, for example, at values of around 10° C./cm or less. If the curvature is not very accentuated, for example, even if the radius of curvature remains small but the opening angle of the corresponding arc remains low, the temperature gradient required may not exceed 5° C./cm.

These gradients correspond over the surface of the glass to temperature differences which do not normally exceed one hundred degrees Celsius. Above that, for the processes based on deformation by gravity, the control of the curvatures would risk being compromised. For less accentuated curvatures, and the processes not comprising forming by pressing, the temperature differences do not ordinarily exceed 50° C. and usually are less than 30° C.

Considering the limited supply of heat corresponding to each heating element, the residence time under this element itself being limited, and the power delivered not being able to exceed certain thresholds which are due, in particular, to the mentioned requirement of having elements with a low thermal inertia, the implementation of the invention is advantageously carried out by using several individual heating elements. To achieve the gradient indicated above, it is necessary, as the examples developed later on show, to involve successively at least ten or so individual elements for the passage of one and the same sheet and often twenty or so or even thirty or so elements. These elements may be assembled in groups to facilitate their use.

The remainder of the description and the examples are made by referring to the process in which the forming is carried out continuously on rollers, optionally before being completed in a frame, but the means and the devices presented may be used in all the techniques requiring a local supply of energy during the bending procedure.

Other features and advantages of the invention will appear on reading the detailed description which follows, for the understanding of which reference will be made to the appended drawings among which:

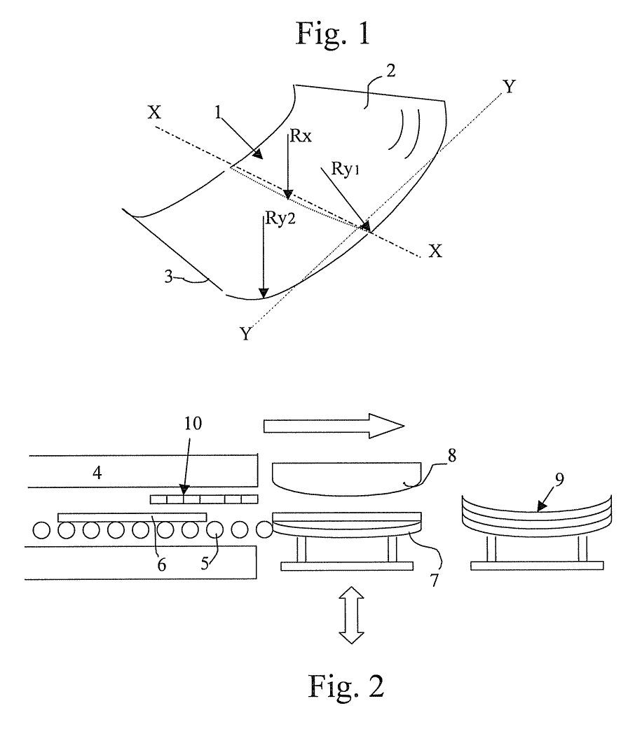

FIG. 1 schematically represents a bent glass sheet having a complex shape of the type for which the implementation of the invention proves particularly useful;

FIG. 2 schematically represents a bending process to which the invention may be applied;

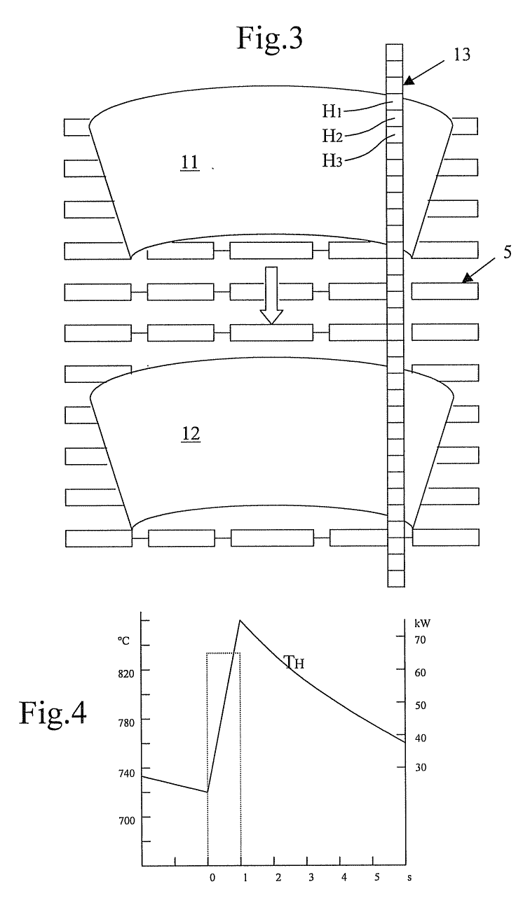

FIG. 3 shows a top schematic view of the part of the process from FIG. 2 relating to the invention;

FIG. 4 is a graph illustrating the typical behaviour of an isolated heating element;

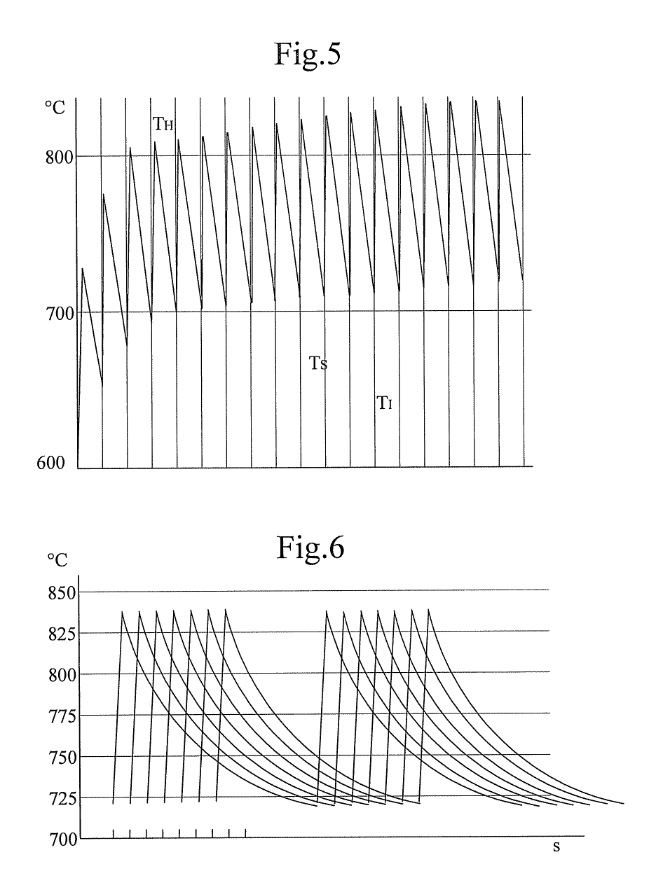

FIG. 5 is a graph illustrating the change in temperatures of a heating element subjected to a series of heating cycles;

FIG. 6 is a graph representing the operation of a series of 5 heating elements during passage of 2 successive glass sheets;

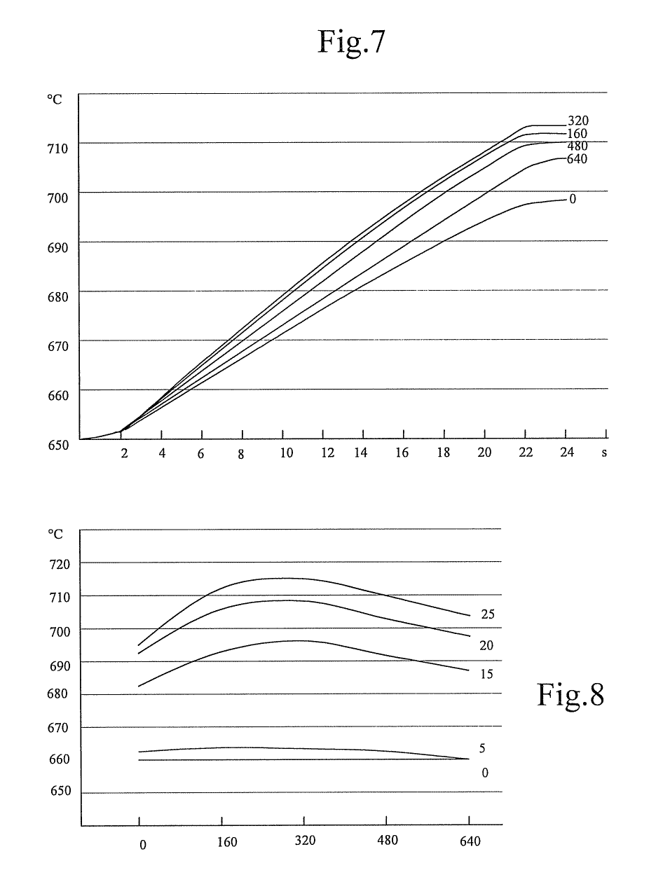

FIG. 7 shows the change at various points of a glass sheet according to the invention exposed to a series of heating elements;

FIG. 8 is the reproduction of the temperature measurements from the preceding figure, showing the arrangement along the glass sheet;

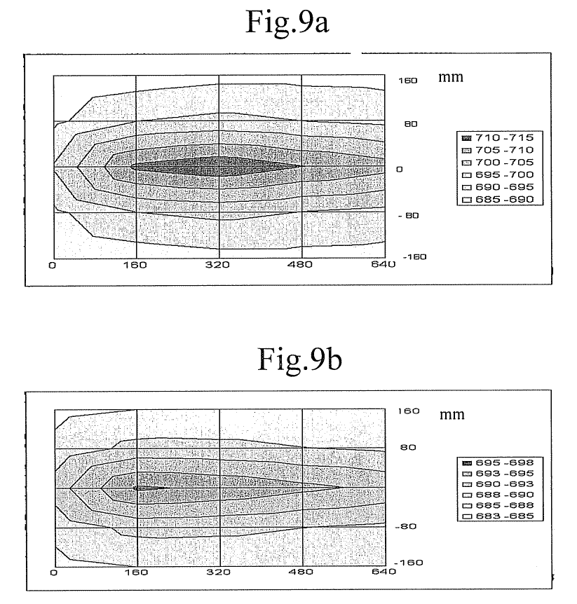

FIGS. 9a and 9b illustrate the temperature distribution over the surface of the glass sheet;

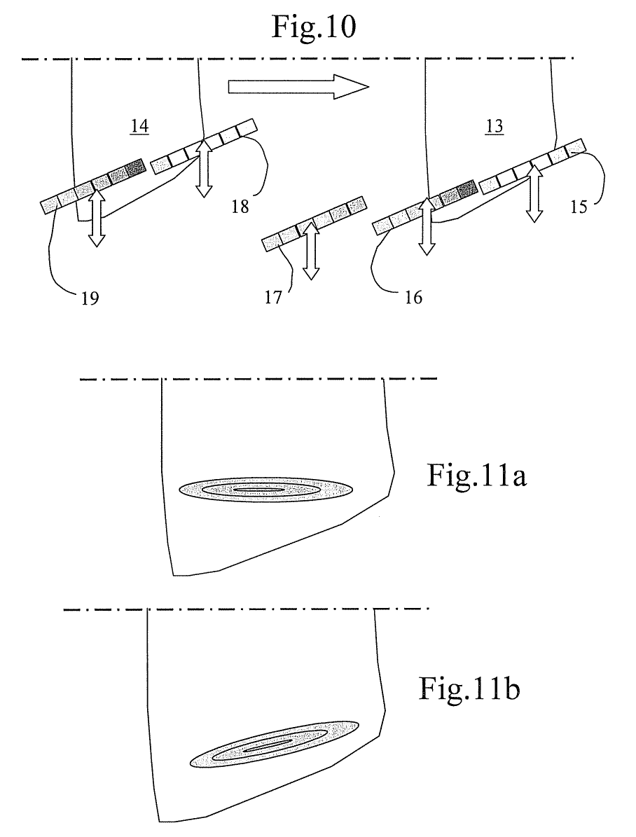

FIG. 10 is a schematic illustration of an implementation method in which the most intense curvature zone is not in the progression direction of the glass sheet; and

FIGS. 11a and 11b show the arrangement of the zones treated according to the invention.

The glass sheet (1) presented in FIG. 1 is of the type comprising a central part of which the radii of curvature (Rx and Ry1) along the directions X and Y, are relatively limited, but which comprises on the edges (2,3) and in the direction Y, wings forming zones of small-radius curvature (Ry2). The conjugation of the curvatures in the small-radius zones imposes a temperature increase to enable adequate bending.

This locally high temperature is all the more necessary when the bonding is carried out by simple effect of gravity. In this case, the bending of the glass in these zones must be facilitated without, however, risking undesirable deformations of the zones of the sheet which must only display a limited curvature. For this reason it is necessary, locally, and in a limited manner over time, to establish a significant temperature gradient between this zone of small-radius curvature and the neighbouring zones of much larger radius.

Such a forming method is of the type of that proposed, for example, in the process described in the prior art patent publication US 2004/0244424 A1 and which is represented schematically in FIG. 2.

In this process the sheet to be bent (6) passes through several conversion steps. In a first step, the sheet is transported by a roller conveyor (5) into a furnace (4) the time to bring it to the suitable temperature for the formation, by gravity, of an intermediate form having curvatures that are not very accentuated.

In the process in question, the formation of limited curvatures is carried out by rapid passage over a series of roller conveyors having a profile of which the curvature is gradually accentuated. The passage time from the rollers to the pressing device is limited so that the glass sheet only undergoes a limited cooling before being subjected to the final bending by pressing using a frame (7) on which the sheet is deposited, a frame which is then applied with the sheet to a counter-mould (8). Once the forming is carried out, the sheet (6) borne by the frame (7) is rapidly cooled in a quenching step (9) to solidify its form and give it the desired mechanical properties.

In this succession the formation of these accentuated curvatures along the edges of the sheet is mainly carried out during the second step, that of pressing the sheet between the frame (7) and the counter-mould (8). The fact of imposing a pressure is not without consequences for the quality of the resulting glazing. The force applied to obtain this high curvature is even larger when the temperature of the sheet has been kept at the level which is necessary for obtaining the prior curvature by simple gravity, without going beyond that in order to avoid excessive deformation.

This force means that, for example, the frame (7) support for the sheet in the pressing step, has a tendency to mark the glass or even to cause breakages. These marks are limited to the periphery of the glazing. They are nevertheless clearly perceptible on the glazing fitted flush to motor vehicles. They are all the more visible when they are located on the side of this glazing turned towards the outside. Similarly the pressure of the sheet on the side of the counter-mould may cause undesirable marks.

The pressing force is also the cause of stresses introduced in the zones of high curvatures, modifying the mechanical characteristics of the sheets.

The strong application of the frame to the sheet also introduces risks of defects in the peripheral zone, these defects which embrittle the sheet. These defects are partly the result of the thermal “shock” caused by the contact of the relatively cold frame with the glass sheet. The higher the pressure exerted, the more intense the heat transfer during contact and the higher the risk of microcracks, chips etc.

The choice of applying the solutions of the invention, namely creating, at the locations of accentuated curvature, a local temperature increase relative to the remainder of the sheet, makes it possible to overcome these difficulties by facilitating the formation of this curvature. In FIG. 2, the local temperature increase is obtained by means a series of heating elements (10) used between the furnace exit (4) before the pressing step.

The difficulty is ensuring that the temperature increase is uniquely concentrated at the locations of the high curvatures and over a sufficiently short time so that during this operation, the formation of marks is avoided, a formation which is favoured by the high temperatures achieved. In practice, the space over which this operation is carried out is covered in less than a minute and advantageously in less than thirty seconds. It is in this restricted time interval that the local temperature difference has to be established. In any case, the designated time for the local overheating is necessarily limited. The temperature gradient that it is endeavoured to develop actually diminishes over time. In practice, the thermal conductivity of the glass at the treatment temperatures remains relatively moderated so that it is not really involved in the choice of processing conditions.

FIG. 3 presents a top view of a diagram of an embodiment of the invention applied, for example, to the process in question above.

The progression of the sheets (11, 12) previously “preformed” by heating to softening point in a furnace (4) of the tunnel type is continued on a roller conveyor (5) before the sheets are placed in the frames (7) for pressing.

Above the sheets (11,12) series of heating elements (13) are arranged opposite the zones of the sheets in which a temperature increase must be applied. In FIG. 3 a single series is represented. Another similar series (not shown) is necessary for a glazing having a symmetrical arrangement.

When the zones in question extend over the entirety of the heights of the sheets, a continuous heating of the elements allows treatment over the whole strip of the sheet facing the heating elements. In so far as the application must be differentiated over the height, that which is the most frequent, it is necessary to proceed according to the invention by ensuring the heat supplies follow the movement of the sheets.

It should be noted that the preheating in the furnace is carried out in an approximately homogeneous way in the progression direction, and the resulting temperature before use of the localized heating elements is relatively uniform.

Generally, the implementation of the invention comprises the localized heat supply, a heat supply which is controlled in order to be applied in any zone, limited both transversely (Y direction) and longitudinally (X direction), of the glass sheet.

The processing principle consists in modulating the operation of the heating elements, such as H1, H2, etc. in FIG. 3, modulation which is controlled as a function of the steady passage of the zone of the sheet of which the temperature must be increased.

The action of each element is controlled over time in order to only occur during the passage of the sheet. The sequences of the elements used are moved with the sheet, the elements themselves remaining essentially immobile in the progression direction of the sheets. The absence of mobility of the heating elements avoids the presence of complex mechanisms located in parts of the installation raised to a high temperature. The production of these devices is therefore facilitated.

In order to be able to effectively modulate the heat supply from the heating elements in the manner which has just been indicated, it is necessary to use elements whose characteristics are capable of being modified in an almost instantaneous manner. In practice, it is however necessary to take into account the limits of the usual processing means, especially the thermal inertia of the heating elements and of their casing. Elements whose inertia is very limited are commercially available. According to the invention, these elements are used in preference to the usual elements such as resistors having a high heat capacity.

The heating elements are moreover advantageously of restricted dimensions in order to be able to apply the supply in as precise a manner as possible. In practice, however, it is superfluous to seek dimensions which would be less than the distance from the heating elements to the glass sheet due to the inevitable dispersion of the heat supply which entrains this distance. Under these conditions although it is advantageous that the elements do not have dimensions of more than 20 cm, in practice dimensions below 5 cm do not bring additional precision for the treated zone, and would lead to the number of elements required being multiplied.

The graph from FIG. 4 illustrates the operation over time of a heating element as used according to the invention. On the graph the time in seconds is shown on the x-axis. The temperatures in ° C. appear on the left-hand y-axis, and the indicative energy supplies delivered by the element considered appear on the right-hand y-axis. The proposed operation is here on/off.

The temperature indicated is that of the heating element TH.

The power applied in the case presented is 60 kW. This power is applied instantaneously to study the degree of rapidity of the response which may be obtained using this heating element.

The initial temperature TH of the heating element is around 725° C. The energy supply passes instantaneously to 60 kW during an interval of one second then is interrupted. The temperature of the heating element during this brief interval progresses extremely rapidly passing from 725 to 830° C. at the moment when the power supply of the element is again interrupted.

The rise in temperature of the element is practically linear. Its rapidity takes into account the low inertia of the effectively active part of the heating element. When the power supply is interrupted the element cools but the temperature decrease is less rapid than the rise, taking into account the inertia of the heating element in its entirety (including its casing) and the manner in which the energy is dissipated from this element. The drop in temperature without any other intervention stretches out, in the case envisaged, over ten or so seconds to practically return to the initial temperature.

The operation of the heating element is not limited to one pulse. FIG. 5 illustrates the behaviour of the heating element having a series of pulses. The test is carried out in a frame and the ambient temperature is set at 600° C. The duration of each pulse is one second, and the time of each cycle is 8 seconds.

The graph from FIG. 5 shows the temperature of the heating element TH. The repetition of multiple pulses necessarily leads to an increase in the temperatures recorded for the heating element both as “peak” and “valley” temperatures. Starting from 600° C., the valley temperature after the 18 pulses climbs to around 710° C.

Starting from the fact that one element is insufficient to raise the temperature so as to create the desired temperature gradient between the treated zone and the remainder of the glass sheet, the elements are put in series one next to another, each operating to reinforce the action of the preceding element.

In the example, which is the subject of FIG. 6, the 7 successive elements as shown in FIG. 3 are activated one after the other, following the same cycles. The presence of the contiguous elements does not modify in any appreciable way their respective behaviour. The pulse trains applied to these various elements systematically target the same zone of each glass sheet. The figure shows two series of pulses for two successive sheets.

In the reported example the first pulse corresponds to the passage, under the zone in question, of the edge of the glass sheet. The drop in temperature and the energy radiated consequently by the first heating element continues to heat the glass after it has progressed and a new element is started up, and so on. The succession of the heating elements and their cumulated effects, including those resulting from the inertia of these elements, results in a gradual heating over the whole of the glass sheet along the direction corresponding to the position of the heating elements.

The principle corresponding to this mechanism is evaluated (FIG. 7) over the change in a glass sheet of which the height along the direction of the series of heating elements is 640 mm. The temperatures are determined at the beginning and at the end of the sheet (points 0 and 640 mm), and at three equidistant points (160, 320 and 480 mm).

The initial temperature of the sheet is 650° C. The operation of each element having a length of 160 mm is systematically one second, and the glass travels at 160 mm/s, thus leading to the start up of each element on passing the edge (point 0) of the sheet.

The temperatures of the various points on the line facing the heating elements shows that it is possible to create appreciable differences. This difference at the end of this additional heating reaches, in the present case, twenty or so degrees between the temperature of the zone subjected to the action of the heating elements and the remainder of the sheet.

FIG. 8 thus illustrates the results from FIG. 7. This presentation shows the distribution of the temperature along the line of additional heating, and its development over time. The successive lines starting from the level 650° C. correspond to the times 5, 15, 20 and 25 seconds. This figure shows the progression of the temperature differences. For one sheet at a uniform temperature of 650° C., the temperature rise is relatively rapid up to around 700° C. The progression then is less marked. The configuration chosen is such that temperatures and temperature differences are achieved that are in excess relative to the usual requirements for the formation of accentuated curvature.

FIG. 9 is a top view representation of the distribution of the temperatures in the plane of the sheet. The heating elements also have a certain width. It shows the distribution by areas on the sheet. FIG. 9a corresponds to an energy of 250 kW/m² and element heating times of 1 second. FIG. 9b is differentiated by heating times of only 0.5 seconds. From this, a possibility can be seen of modulating the temperature gradient imposed and similarly the maximum temperatures achieved.

In the case presented in 9a, the difference obtained is around 25 to 30° C. In the case 9b the difference is significantly more reduced between the hottest zones and the remainder of the sheet, around twenty or so degrees.

The arrangement of the bending directions is not most frequently parallel to the axis of the glazing. On the contrary, these lines of curvature, for glazing of the rear window or windscreen type for example, generally follow oblique directions, more or less parallel to the edges of this glazing which usually has a trapezoidal shape.

FIGS. 11a and 11b schematically illustrate the two types of location of the zones receiving the additional heating. Shown in 11a is a zone resulting from heating carried out as previously in a direction parallel to the axis of progression of the glass, whereas FIG. 11b corresponds to a zone of high curvature located approximately parallel to the edges of the sheet.

To respond to this arrangement, it is necessary to ensure that the heating elements are located as shown in FIG. 10, therefore following a certain angle relative to the axis of progression of the glass sheet. In order to take into account the various shapes to be treated, the heating elements are therefore advantageously arranged so as to be able to pivot to present the angle corresponding to the shape of the glazing treated. Furthermore, in order to take into account the relative movements of the sheet and the heating elements, these are for example movable in translation in a transverse direction relative to the progression direction and are driven by a movement that guarantees, at any moment, the positioning of these elements along the line of high curvature of the glazing. In FIG. 10, the progression direction of the glass is indicated by a single arrow pointing from left to right.

Two sheets (13, 14) pass under several series of heating elements (15, 16, 17, 18, 19), all making the same angle with the axis of progression of the sheets. Each series is driven by an alternate translational movement symbolized by a double arrow, a movement which is of transverse direction relative to the displacement direction of the glass sheets. During passage of a sheet, for example (14), a first series (19) of heating elements comes into position above the zone of the sheet to be heated locally. This first series then gradually passes from a position closest to the axis of the device (position which is that, at this time, of a second series of heating elements 18) to the furthest position by the movement taking it away from this axis to occupy the extreme position which is that of the element from the series of elements (17) at the moment in question. The movement in the reverse direction takes place to bring the successive elements back into position above the zone of the sheet to be heated.

By varying this arrangement it is also possible to use batteries of heating elements stretching out in two directions and distributed in a chequerboard fashion. In this case an adequate control of the series of elements following one another in a suitable diagonal direction makes it possible to reproduce the line without having to mobilize the heating elements.

1. Process for bending glass sheets comprising heating of the entire glass sheet progressing continuously into a furnace, heating to a temperature close to the softening point of the sheet, and application, to the thus preheated sheet, of localized heating in the zones of the sheet that have to undergo the highest curvatures, the localized heating being carried out by means of heating elements located opposite the high curvature zones, the progression of the sheet being followed by the successive start of or increase in the power delivered from one or more series of heating elements positioned opposite the zones of the sheet subjected to this additional heating.

2. Process according to claim 1, in which the temperature of the glass sheet, prior to the localized heating, is above 550° C.

3. Process according to claim 2, in which the temperature of the glass sheet, prior to the localized heating, is above 600° C.

4. Process according to claim 1, in which the high-curvature zones of the sheets are subjected to a localized heating to lead to a temperature gradient of the zones, relative to the rest of the sheet which is at most equal to 10° C./cm.

5. Process according to claim 4 in which the temperature gradient is at most equal to 5° C./cm.

6. Process according to claim 1 in which the localized heating of the glass sheet is carried out over a time which does not exceed 60 seconds and advantageously does not exceed 30 seconds.

7. Process according to claim 1 in which the localized heating is provided by means of a series of heating elements having a dimension in the progression direction of the glass sheets such that the exposure time of one point of the sheet to this heating element of this series is not more than 2 seconds, and advantageously not more than 1 second.

8. Process according to claim 1 in which the succession of starts or increases in the power delivered by each heating element of a series of elements, follows the progression of the glass sheets in an approximately synchronized manner.

9. Process according to claim 1 in which each individual heating element has a dimension in the progression direction of the glass sheet which is not greater than 20 cm.

10. Process according to claim 1 in which the series of heating elements are aligned in a non-parallel direction to the progression direction of the glass sheets.

11. Process according to claim 10 in which the series of heating elements can be moved in a transverse direction to the progression direction of the glass sheets, these series being driven by a translational movement keeping the series of elements opposite the zone of the sheet that has to undergo a localized heating during the progression of this sheet.

12. Process for bending glass sheets in which the glass sheets are transported along a tunnel furnace bringing them to the softening point and on a roller conveyor of which the arrangement ensures a first bending, the pre-bent sheets, being subjected to a localized heating along the zones of the sheets that have to undergo low-radius curvatures until a sufficient temperature gradient is obtained in these zones to facilitate the subsequent formation of these curvatures, and comprising a final bending step during which the low-radius curvatures are produced.

13. Process according to claim 12 in which the final bending is obtained by a pressing operation, this operation comprising the positioning of the pre-bent and locally overheated sheets in a frame having a shape and dimensions that correspond to the periphery of the sheets, which frame applies the sheets to a counter-mould giving the sheets their final shape, the sheets thus formed then being cooled.
